(19) United States
(12) Patent Application Publication
(10) Pub. No.: US 2025/0245371 A1
(43) Pub. Date: Jul. 31, 2025

(54) Secure LLM Facilitated Database Access

(71) Applicant: Lookout Inc., Boston, MA (US)

(72) Inventors: Benjamin Zalasky, Chesterfield, MO (US); Eugene Tiutiunnyk, San Francisco, CA (US)

(21) Appl. No.: 18/427,165

(22) Filed: Jan. 30, 2024

(51) Int. Cl. G06F 21/62; G06F 16/33

(52) U.S. Cl. CPC G06F 21/6227; G06F 16/3344

(57) ABSTRACT

Secure access to a database is facilitated by an LLM. A natural language (NL) query is received and passed to an LLM in a prompt along with all or part of a commands for accessing a database without passing the data stored in the database. The prompt may further include instructions to generate one or more commands to access the database to retrieve data responsive to the query. The instructions may instruct the generation of a URL to access relevant data. Data responsive to the command may be embedded in a document presented to a user. The document may be selected by the LLM in response to a second prompt. The command is executed with respect to the database only upon validating access of a user to the data referenced by the command.

### BACKGROUND

Large Language Models (LLM) may be used to process large amounts of textual data and develop an “understanding” of relationships between words such that the LLM is able to respond to natural language questions or instructions (“prompts”) with coherent text. LLMs may be used to generate summaries of longer texts or generate new text based on a prompt. However, experiments have shown that, with the proper prompt, an LLM can reproduce a text used to train the LLM.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment for performing methods in accordance with an embodiment of the present invention;

FIGS. 2A and 2B are process flow diagrams of methods for securely facilitating access to a database using an LLM in accordance with an embodiment of the present invention;

FIGS. 3A and 3B are process flow diagrams of methods for generating visualizations of data using responses from an LLM in accordance with an embodiment of the present invention;

FIG. 4 is a process flow diagram of a method for using an LLM to account for access privileges when facilitating database access in accordance with an embodiment of the present invention; and

FIG. 5 is a schematic block diagram of a computer system suitable for implementing methods in accordance with embodiments of the present invention.

### DETAILED DESCRIPTION

It will be readily understood that the components of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written in any combination of one or more programming languages, including an object-oriented programming language such as Java, Objective-C, Swift, C++, or the like and conventional procedural programming languages, such as the “C” programming language or similar programming languages, and may also use descriptive or markup languages such as HTML, XML, JSON, and the like. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

LLM models have started a paradigm shift in artificial intelligence and profoundly impacted our interaction with technology to manage information. These models have democratized access to advanced AI capabilities, enabling a wide range of users, from businesses to individual creators, to leverage their sophisticated natural language processing skills. This democratization has led to innovative applications across various sectors, including customer service, cybersecurity, content creation, education, and more. The ability of LLMs to understand context, generate coherent and contextually relevant responses, and even exhibit creative capabilities marks a significant leap from the past's more rigid and rule-based systems.

However, with these advancements come significant concerns, particularly regarding privacy and control. The vast amount of data these models are trained on, which often includes publicly available internet text, raises serious privacy issues. There's a risk of these models inadvertently revealing or replicating sensitive information. Additionally, these models may not comply with country-specific laws about what kind of information can be revealed, specifically if the model has access to sensitive information such as emails of all employees in a particular organization or any other personal information.

For example, granting LLM models access to sensitive SQL databases, whether directly or through backend services, inherently involves sharing sensitive information within the database with the LLM and a third party, typically the provider of the LLM. While there is a potential risk of hacking, such as through SQL injection attacks or malicious queries, the primary concern lies in the fundamental requirement of disclosing sensitive data to external entities, which could be a significant security risk if the system is not designed with robust safeguards.

In the industry, there is a demand for LLM models to facilitate user interactions and assist in achieving goals related to sensitive data, all while being designed to operate within such systems without having access to or exposure to sensitive data.

The invention described herein relates to providing secure access to a database that is facilitated by an LLM. A natural language (NL) query is received and passed to an LLM in a prompt along with all or part of a commands for accessing a database without passing the data stored in the database. The prompt may further include instructions to generate one or more commands to access the database to retrieve data responsive to the query. The instructions may instruct the generation of a URL to access relevant data. Data responsive to the command may be embedded in a document presented to a user. The document may be selected by the LLM in response to a second prompt. The command is executed with respect to the database only upon validating access of a user to the data referenced by the command, thus not exposing sensitive data (such as data related to privacy, control, personal information etc.).

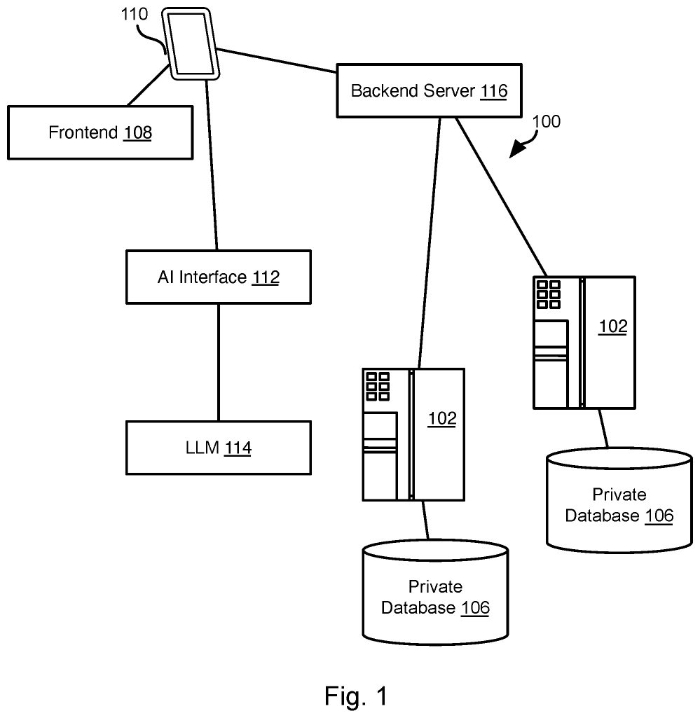

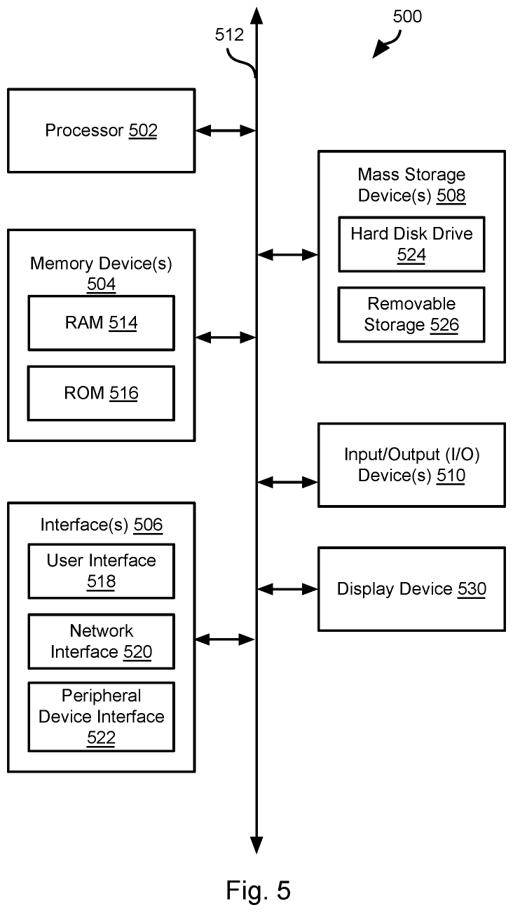

FIG. 1 illustrates a network environment 100 of an enterprise in which the systems and methods disclosed herein may be implemented. The network environment 100 may include one or more server system 102 that includes one or more computers. The server systems 102 may be embodied as one or more computing devices 500 as described below with respect to FIG. 5. The server systems 102 may host or access one more databases 106 storing private data, such as proprietary data, private customer information, health records, or the like. In the description below, databases 106 are mentioned as examples of data that may be securely accessed using an LLM as described herein. However, any data, including data that is not necessarily stored in and access according to a database protocol may be accessed in a like manner.

The server systems 102 may be accessed by a frontend 108. The frontend 108 may be a webpage, executable code embedded in a webpage (e.g., JAVASCRIPT), client application, application programming interface (API) or other application executing on user devices 110. The user device 110 and server systems 102 may be connected to one another by a network, such as a local area network (LAN), wide area network (WAN), the Internet, or any other type of wired or wireless network connection (e.g., 2G, 3G, 4G, 5G). User devices 110 may communicate via the Internet over a cellular data network, WI-FI or other communications technologies, or other portable computing devices (e.g., devices that pair with a mobile device using BLUETOOTH, such as a smart watch).

User devices 110 may be embodied as a smartphone, a laptop computer, a desktop computer, a mobile device, a wearable computing device, a personal digital assistant (PDA), a tablet computer, an electronic book or book reader, a digital camera, a video camera, a video game console, a voice processing device or executable in a device (voice controlled, voice transcribing, voice recording, voice recognizing, etc.), a drone, a UAV, a vehicle, a personal robot, a robotic appliance, a smart TV, a set top box, a router, a cable modem, a tablet, a server, a thing in IoT, an ambient computing device (located in a mostly fixed location in a room or location, available to multiple users located in the vicinity of the device, smart rooms, etc.), and/or any other suitable computing device.

A user device 110 may include any computer or computing device running an operating system for use on handheld or mobile devices, such as smartphones, PDAs, tablets, mobile phones and the like. For example, a mobile device may include devices such as the Apple iPhone®, the Apple iPad®, or any device running the Apple iOS™, Android™ OS, Google Chrome™ OS.

The frontend 108 receives and responds to user queries as described herein. The frontend 108 may alternatively be executed on one or more of the server systems 102 or on one or more separate computer systems, such as one having some or all of the attributes of the computing device 500.

The frontend 108 may be connected by the network to an artificial intelligence (AI) interface 112. The AI interface 112 may be implemented by one or more server systems 102 or some other computing device. The AI interface 112 may generate inputs to a machine learning model in response to user queries received by way of the frontend 108. For example, the AI interface 112 may input queries, and/or data derived therefrom, into a large language model (LLM) 114. The AI interface 112 may further receive responses to the user queries and/or other data from the LLM 114 and pass the responses to the frontend 108, possibly with modification as discussed in greater detail below.

The frontend 108 may output responses from the LLM on the user device 110 directly or with further processing. In particular, the frontend 108 may process the responses to obtain one or more commands to submit to a command interpreter, such as an interpreter of database commands executing on a server system 102 in order to retrieve data from a database 106. The command interpreter may be a router in the frontend 108 or some other module or API. The commands may be included in a document provided to user device 110, such as webpage (e.g., hypertext markup language (HTML) document with links that, when clicked, invoke execution of the command. Each command may be embodied as a uniform resource locator (URL) referencing a computer system, directory, or other resource in the database 106. The command may include parameters for reading data from the database 106. The command may alternatively or additionally include a structured query language (SQL) command or a command according to any other database language known in the art.

The frontend 108 may format the data received in response to the command and output the formatted data on a display of the user device 110. Formatting the data may include generating a visualization, e.g., graph or other type of diagram. Formatting may include generating a webpage with multiple tabs or other user interface elements to control what data is displayed and/or how data is displayed.

In some embodiments, one or more backend servers 116 may also be used. The backend servers 116 may provide support services, implement access control, or otherwise facilitate access to the server systems 102 or other services.

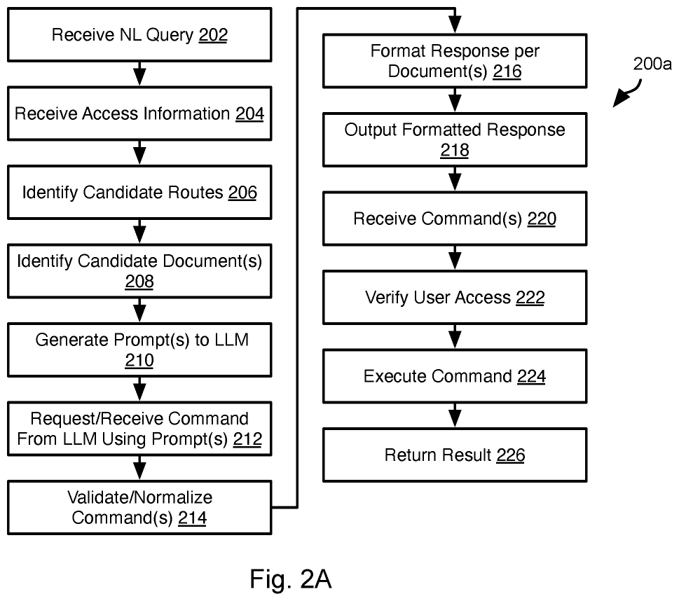

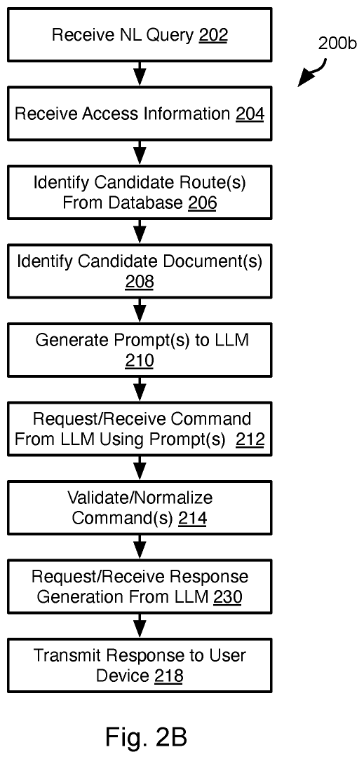

FIG. 2A illustrates an example method 200a that may be performed using the network environment 100 or other computing environment. The description of the method 200a includes an example division of functions between the frontend 108, AI interface 112, backend server 116, and a server system 102 with the understanding that this division is exemplary only and that the functions may be divided differently among the illustrated components or be performed by fewer components, including a single component.

The method 200a may include receiving, at step 202, a natural language (NL) query. The NL query may be in the form of a sentence, phrase, question, or other human intelligible statement according to any language, e.g., “how many device have this vulnerability” or “how many devices are using licenses for [software].” The NL query may be received as a recording of speech that is subsequently transcribed to text using a speech-to-text algorithm. In some embodiments, the NL query is not code according to SQL or other programming language, i.e., a language used to execute queries with respect to any of the databases 106.

The method 200a may include receiving, at step 204, access information for a source of the NL query, e.g., a user identifier with respect to which the user device 110 is authenticated. The access information may include any information defining a scope of access associated with a role assigned to the user identifier. The role may include a job title or membership within a business unit, department, group of users, or other set of users having access control information associated therewith. The access control information may specify which databases 106 or portions tables, columns of tables, etc. are accessible using the user identifier or a role associated with the user identifier. The access control information may be in the form of one or more routes that may be accessed. The access information may be in the form of a certificate or token (e.g., JAVASCRIPT object notation (JSON) token) that can be used to authenticate the user device 110. Step 204 may be performed simultaneously or as part of step 202, e.g., the NL query may be received along with access information for the user identifier with respect to which the source (user device 110) of the NL query is authenticated.

The method 200a includes identifying, at step 206, candidate routes from one or more databases 106. For example, each database 106, a portion of each database 106, each table of each database 106, or some other subset of each database 106 may have a corresponding schema. The schema may exclude any confidential, private, or sensitive data. The schema defines the organization of the one or more databases 106 and may include such information as database names, table names, field names, data types, or relationships between databases 106, tables, fields, and/or data types. The schema may include a hierarchical representation of commands for accessing a database 106, table, or a portion thereof. In particular, commands in the schema may reference data with the database 106 and possibly include one or more database operations (select, union, join, filter, etc.). A route may be defined with respect to the schema and may include a listing of one or more database access language (e.g., SQL) commands, database names, one or more table names, names of one or more columns of a table, or other representation of the location of data within the database 106. The route may be in the form of a navigational path listing commands from general to specific within a hierarchical representation of commands for accessing data within the database 106.

Identifying, at step 206, candidate routes may include processing the NL query and selecting a route that is relevant to the NL query. In particular, words and phrases in the query may be searched with respect to labels of entities (tables, columns, etc.) stored in the database 106 as listed in the schema. The manner in which the search is performed may be according to any text-based search algorithm known in the art. Identifying, at step 206, candidate routes may include identifying routes that only include commands accessing data that is accessible by the user identifier with respect to which the user device 110 is authenticated.

Step 206 may include identifying commands through a schema that may be a route or some other representation of commands for accessing data within a schema. Likewise, throughout the following description, a “route” may also be understood as possibly being replaced with any other command defined with respect to a schema, such as a command through a schema.

The method 200a may include identifying, at step 208, candidate documents from a document set. As used herein a “document” may be a paragraph, sentence, or the entire contents of a document file. The candidate documents may include text that may be used to present results for the NL query to the user. The documents may therefore include HTML documents in which links to commands for accessing a database 106 may be embedded. The documents may include documents including common NL queries and corresponding routes and/or database access commands (e.g., URLs) for the queries. The documents may be obtained by parsing a document set and generating, for each document, a vector representation thereof. The vector representation may specify relationships between words in the document and other words in a corpus of words. The relationships represented by the vector representation may represent semantic relationships, co-occurrence relationships, or any other relationship between words that may be used to compare similarity of a document to an NL query.

Identifying, at step 208, candidate documents may therefore include evaluating the NL query with respect to the vector representation of documents and identifying one or more documents that are relevant to the NL query, such as one, two, or more documents. The manner in which the NL query is evaluated with respect to the vector representations of documents may be according to any approach known in the art.

The method 200a may then include generating, at step 210, one or more prompts to submit to the LLM 114. The items of information may include the NL query itself and the one or more candidate routes identified at step 206.

Step 210 may include inserting the query and the one or more candidate routes into fields of a template to obtain the prompt. For example, the prompt may be of the form:
Generate a uniform resource locator that references data describing how many devices have [vulnerability] in a database including the following routes:
[candidate routes]

Each prompt may further include more detailed instructions describing how the prompt is to be generated, such as how to interpret the route, the format that the URL should have, one or more examples including a NL query and one or more routes with a corresponding URL generated by a human operator or other approach.

The method 200a may include requesting, at step 212, generation of a command by the LLM 114 by submitting the one or more prompts from step 210 to the LLM 114 and receiving a command generated by the LLM in response to the one or more prompts. In the examples herein the “command” is a URL referencing data within one or more databases 106. However, the command could be one or more SQL commands, multiple URLs, or commands according to some other database language or other programming language. The one or more commands may act upon data with the database 106, such as format, render, display, write to, delete, or perform one or more database operations (select, union, join, filter, write, delete, etc.).

At step 214, the method 200a may include validating and/or normalizing the command received from the LLM 114 in response to the request from step 212. Validating and normalizing may include correcting errors in formatting, removing entities in the command that do not belong to the routes provided to the LLM 114, removing non-executable text, or performing other corrections.

The command as modified at step 214 may be further formatted, at step 216. For example, step 216 may include formatting a response incorporating the command output from step 214 according to the one or more candidate documents identified at step 208. For example, step 216 may include associating one or more commands (e.g., URLs) with hyperlinks in an HTML document (underlined text indicates hyperlink):
“To see devices having [vulnerability] click on this link and select the tab labeled [vulnerability].”

The response as formatted at step 216 may be output, at step 218, on a display of the user device 110 from which the NL query was received at step 202. A user of the user device 110 may then invoke execution of the command included in, or otherwise associated with, the response. For example, step 218 may include rendering the response on the user device 110. The user may then select a hyperlink included in the response to invoke transmission of an instruction to execute the command by one or more of the server systems 102. The instruction may be a call to an API implemented by the server system 102. Executing the command may include performing API to API interaction with the server system 102.

In response to receiving, at step 220, the instruction to execute the command, the method 200a may include verifying, at step 222, that a source of the instruction is authorized to access data referenced by the command. For example, step 222 may include verifying that a user identifier with respect to which the user device 110 is authenticated has a role associated with access privileges to the data referenced by the command.

If the source of the instruction is not verified, the instruction is ignored. If so, then the command, e.g., the command from step 214 referenced by the instruction, is forwarded to a server system 102. The server system 102 then executes, at step 224, the command and returns, at step 226, a result of the command to the user device 110 directly or by way of some other component, such as the backend server 116. Step 226 may include formatting the result. For example, step 226 may include generating a graph or other visualization or generate a webpage including the result for rendering in the browser or client application executing on the user device 110.

In some embodiments, steps 224 and 226 may be performed earlier in the method 200a. For example, following step 206, relevant routes are known. Data referenced by the relevant routes may be pre-fetched by the frontend 108 from the server system 102. The frontend 108 may then respond to any request to execute the command with the pre-fetched data. Likewise, as soon as the command is received from the LLM, the data referenced by the command may be pre-fetched from the server system 102 and be available to provide to the user device 110 when execution of the command is requested.

As is apparent from the description above, the method 200a enables use of the ability of the LLM 114 to interpret natural language and understand semantic relationships to help a user navigate a database 106 while at the same time withholding, from the LLM 114, access to the actual data in the database 106.

Steps 202-226 may be performed in various ways by various components of the network environment 100. For example, steps 202, 204, 206, 208, 216, 218, and 220 may be performed by the frontend 108. Steps 210, 212, and 214 may be performed by the AI interface 112. Steps 222, 224 may be executed by the server systems 102 or combination of the server systems 102 and the backend server 116. Where steps of the method 200a are performed by different components, the method 200a will include communication between the results of the components: the result of a step performed by the first component being provided to a second component performing a subsequent step.

FIG. 2B illustrates an alternative method 200b for facilitating secure access to a database 106. The method 200b may include performing some or all of steps 202-214 as described above. However, the command, e.g., following any validation/normalization step 214, and one or more other items of data may be used to request, at step 230, generation of a response by the LLM 114.

For example, the method 200b may include passing some or all of the NL query, the command, the candidate routes or other portion of the schema, and one or more candidate documents to the LLM as part of a prompt requesting, at step 230, that the LLM generate a response incorporating the command (e.g., an HTML document including a hyperlink to the command) and communicating to the recipient of the document how to access the data referenced by the command. The generated response may incorporate aspects of one or more documents identified as relevant at step 206.

Step 230 may include receiving, at step 230, a response to the prompt from step 230, which may be either a document that incorporates the command or a document into which the command may be embedded, such as in the form of a hyperlink. The method 200b may then include transmitting the response to the user device 110, which may then render the directly or by way of the frontend 108. The command embedded in the response may then be executed, such as according to steps 220-226 described above.

The method 200b has the additional advantage of using of the ability of the LLM 114 to interpret natural language and understand semantic relationships to provide a human-readable document including the result of the command while still withholding, from the LLM 114, access to the actual data in the database.

Steps 202-214, 230, and 218 may be performed in various ways by various components of the network environment 100. For example, steps 202-208 and 218 may be performed by the frontend 108. Steps 210, 212, 214, and 230 may be performed by the AI interface 112. Steps 220-226 (see FIG. 2A) may be executed by the server systems 102 or combination of the server systems 102 and the backend server 116. Where steps of the method 200b are performed by different components, the method 200b will include communication between the results of the components: the result of a step performed by the first component being provided to a second component performing a subsequent step.

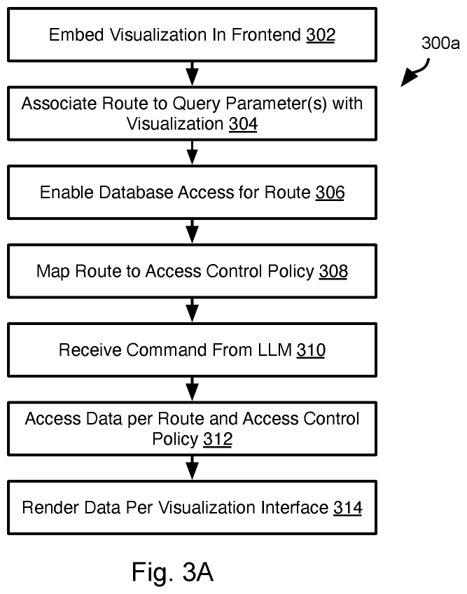

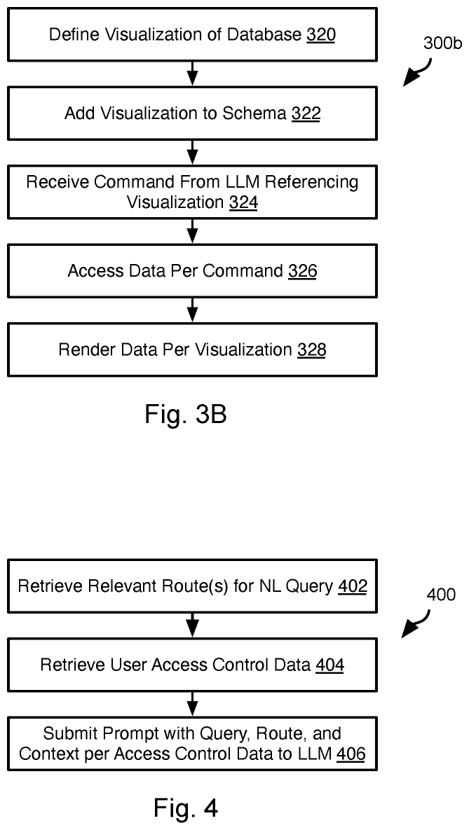

FIG. 3A illustrates a method 300a that may be performed by and with respect to the frontend 108. In particular, the method 300a may be used to generate visualizations of data identified and retrieved according to the methods 200a, 200b or other approach.

The method 300a may include embedding, at step 302, a visualization in the frontend 108 and associating, at step 304, a route to one or more query parameters with the visualization. The visualization may be a web page, executable code for rendering data from a database table, formatting instructions for use by a visualization tool, or the like. The route may be a route as defined above and the query parameters may be entities in a schema: database commands, table names, column names, or other properties of a database 106 that may be referenced in a query to the database 106.

The method 300a may further include enabling, at step 306, access to the route by the frontend 108 and mapping, at step 308, the route to an access control policy. The access control policy may specify roles or specific user identifiers that are allowed to access data referenced by the route.

The method 300a may include receiving, at step 310, a command generated by the LLM 114, such as by way of the AI interface 112. The command may be generated according to the method 200a or 200b. The command may be a URL as described above and may reference a path within the route from step 304.

In response to receiving, at step 310, the command, the frontend 108 accesses, at step 312, data referenced by the command. Accessing, at step 312, the data by the front end 108 may be conditioned on the user identifier associated with the command (e.g., the source of the NL query) being authorized to access the data according to the access control policy of step 308. The frontend 108 may then render, at step 314, the data according to the visualization embedded in the frontend 108 at step 302. Rendering, at step 314, the data may include generating a graphic (table, graph, other visualization). The graphic may be embedded in a webpage transmitted to the user device 110 or otherwise transmitted to the user device 110.

FIG. 3B illustrates a method 300b that may be performed by and with respect to the frontend 108. In particular, the method 300b may be used to generate visualizations of data identified and retrieved according to the methods 200a, 200b or other approach.

The method 300b includes defining, at step 320, a visualization of a database 106, e.g., a particular table or tables of a database 106. The visualization may be a graph or other type of visualization. The visualization may be a web page, executable code for rendering data from a database table, formatting instructions for use by a visualization tool, or the like. The method 300b may further include adding, at step 322, the visualization to a schema. For example, the visualization may be added as a node on a route through the schema referencing data rendered by the visualization.

The method 300a may include receiving, at step 324, a command generated by the LLM 114, such as by way of the AI interface 112. The command may be generated according to the method 200a or 200b. The command may be a URL as described above and may reference a path within the route within the schema that includes the visualization from step 322.

In response to receiving, at step 324, the command from the LLM referencing the visualization, the frontend 108 accesses, at step 326, data referenced by the command provided that the user identifier associated with the command (e.g., the source of the NL query) is authorized to access the data according to an access control policy applicable to the data. The frontend 108 may then render, at step 328, the data according to the visualization from step 320. Rendering, at step 328, the data may include generating a graphic (table, graph, other visualization). The graphic may be embedded in a webpage transmitted to the user device 110 or otherwise transmitted to the user device 110.

The methods 300a, 300b are exemplary only. In yet another approach, the prompt to the LLM 114 may reference instructions, the instructions being executable by a microservice, application programming interface (API), compiler, or other executable. The instructions may, for example, instruct how to render the data referenced in the command within a dashboard accessible by the user device 110. The instructions in the command may therefore instruct a dashboard or other interface how to render data referenced in the command. The frontend 108 may therefore respond to an instruction to execute the command by rendering the data in the dashboard or other interface.

In yet another example, webpages are defined for rendering data. The command may therefore include a call to a webpage to render the data referenced by the command. The call may include one or more filter parameters restricting the data to be rendered on the webpage to that which is relevant to the NL query as selected by the LLM. In this example, the prompt may therefore reference possible webpages as well as available filter parameters for the LLM to select from.

Referring to FIG. 4, the LLM may additionally be used to evaluate access controls while still withholding actual access to any database 106. The method 400 of FIG. 4 may be executed by the AI interface 112 alone or in cooperation with the frontend 108. The method 400 may be performed as part of performing the method 200a or 200b. The method 300 includes retrieving 402 one or more routes that are relevant to an NL query (see step 206, above). Alternatively, all routes for one or more databases may be used without regard to relevance.

The method 400 may include retrieving, at step 404, access control data. The access control data may include accessing a role associated with a user identifier, e.g., the user identifier with respect to which the user device 110 is authenticated, the NL query being received from the user device. The access control data may include role-based access control (RBAC) information associated with one or more databases 106 and/or portions of databases 106. The roles of the RBAC may be associated with the schema: a particular portion (e.g., route) of the schema may have one or more roles associated therewith. The access control data may define entitlements of a tenant of one or more database 106. The access control data may include a feature flag configuration.

The method 400 may include submitting, at step 406, a prompt to the LLM 114. The prompt may include any of the items described hereinabove as being submitted with a prompt, such as the NL query, the schema (or routes from the schema that are identified as relevant), one or more documents (see step 230), or other information. The prompt from step 406 further includes a context. The context may be a security context including some or all of the access control data or data derived therefrom. The prompt may further include instructions to generate a command that will retrieve data relevant to the NL query and that is authorized according to the context.

A response received from the LLM 114 may be processed according to the method 200a or 200b. In particular, although the LLM 114 was provided the context, the response from the LLM 114 may still be validated (see step 214) to ensure that the data referenced in any command provided by the LLM 114 is accessible for the user identifier.

The method 400 is one example of an approach for an LLM 114 to account for access control data. In an alternative approach, a database 106, or portion of a database, is modified to replace sensitive data (possibly all data) with placeholder data. The placeholder data may be coded such that the original data represented by the placeholder data can be identified by the frontend 108, AI interface 112, server system 102, or some other component.

The methods 200a, 200b may therefore be modified by providing the placeholder data to the LLM 114 either in place of or in addition to the schema or relevant routes from the schema. The LLM 114 may therefore select placeholder data relevant to the NL query and return the placeholder data to the AI interface 112. The placeholder data may then be replaced with the corresponding actual data from the database 106 and provided to the user device, provided the user device is authenticated with respect to a user identifier that has access to the actual data.

In still other embodiments, the actual data retrieved from the database 106 is obfuscated before being returned to the user device 110 regardless of authorization, such as through tokenization or other technique.

FIG. 5 is a block diagram illustrating an example computing device 500 which can be used to implement the system and methods disclosed herein. The one or more computers of the server system 102 and the user devices 110 may have some or all of the attributes of the computing device 500. In some embodiments, a cluster of computing devices interconnected by a network may be used to implement any one or more components of the invention.

Computing device 500 may be used to perform various procedures, such as those discussed herein. Computing device 500 can function as a server, a client, or any other computing entity. Computing device can perform various monitoring functions as discussed herein, and can execute one or more application programs, such as the application programs described herein. Computing device 500 can be any of a wide variety of computing devices, such as a desktop computer, a notebook computer, a server computer, a handheld computer, tablet computer and the like.

Computing device 500 includes one or more processor(s) 502, one or more memory device(s) 504, one or more interface(s) 506, one or more mass storage device(s) 508, one or more Input/Output (I/O) device(s) 510, and a display device 530 all of which are coupled to a bus 512. Processor(s) 502 include one or more processors or controllers that execute instructions stored in memory device(s) 504 and/or mass storage device(s) 508. Processor(s) 502 may also include various types of computer-readable media, such as cache memory.

Memory device(s) 504 include various computer-readable media, such as volatile memory (e.g., random access memory (RAM) 514) and/or nonvolatile memory (e.g., read-only memory (ROM) 516). Memory device(s) 504 may also include rewritable ROM, such as Flash memory.

Mass storage device(s) 508 include various computer readable media, such as magnetic tapes, magnetic disks, optical disks, solid-state memory (e.g., Flash memory), and so forth. As shown in FIG. 5, a particular mass storage device is a hard disk drive 524. Various drives may also be included in mass storage device(s) 508 to enable reading from and/or writing to the various computer readable media. Mass storage device(s) 508 include removable media 526 and/or non-removable media.

I/O device(s) 510 include various devices that allow data and/or other information to be input to or retrieved from computing device 500. Example I/O device(s) 510 include cursor control devices, keyboards, keypads, microphones, monitors or other display devices, speakers, printers, network interface cards, modems, lenses, CCDs or other image capture devices, and the like.

Display device 530 includes any type of device capable of displaying information to one or more users of computing device 500. Examples of display device 530 include a monitor, display terminal, video projection device, and the like.

Interface(s) 506 include various interfaces that allow computing device 500 to interact with other systems, devices, or computing environments. Example interface(s) 506 include any number of different network interfaces 520, such as interfaces to local area networks (LANs), wide area networks (WANs), wireless networks, and the Internet. Other interface(s) include user interface 518 and peripheral device interface 522. The interface(s) 506 may also include one or more user interface elements 518. The interface(s) 506 may also include one or more peripheral interfaces such as interfaces for printers, pointing devices (mice, track pad, etc.), keyboards, and the like.

Bus 512 allows processor(s) 502, memory device(s) 504, interface(s) 506, mass storage device(s) 508, and I/O device(s) 510 to communicate with one another, as well as other devices or components coupled to bus 512. Bus 512 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 500, and are executed by processor(s) 502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

1. A method for responding to a natural language query without exposing sensitive information, the method comprising:
receiving, by a computer system, the natural language query from a device associated with access control information;
invoking, by the computer system, evaluation of the natural language query and at least a portion of a schema of commands for accessing and viewing data by a large language model (LLM) to obtain a command referencing the data;
verifying access to the data according to the access control information; and
in response to verifying access to the data according to the access control information, executing the command with respect to a command interpreter to act upon the data.

2. The method of claim 1, wherein invoking evaluation of the natural language query and the at least the portion of the schema by the LLM comprises refraining from passing any portion of the data to the LLM.

3. The method of claim 1, wherein the at least the portion of the schema comprise one or more commands through the schema.

4. The method of claim 3, further comprising identifying the one or more commands through the schema as being relevant to the natural language query.

5. The method of claim 3, wherein the one or more commands through the schema reference one or more visualizations for the data.

6. The method of claim 5, further comprising rendering, by the computer system, the data according to a visualization of the one or more visualizations referenced by the command.

7. The method of claim 1, wherein the command is a uniform resource locator (URL).

8. The method of claim 1, further comprising passing a security context to the LLM, the security context including the access control information.

9. The method of claim 1, further comprising:
identifying a document relevant to the natural language query from a document set;
incorporating the command in a response generated based on the document; and
returning the response to a user device from which the natural language query was received.

10. The method of claim 1, further comprising:
identifying a plurality of documents and/or commands relevant to the natural language query from a document set;
submitting the command and the plurality of documents to the LLM with an instruction to generate a response to the natural language query based on the plurality of documents and/or commands; and
returning the response to a user device.

11. A non-transitory computer-readable medium storing executable code that, when executed by one or more processing devices, causes the one or more processing devices to:
receive a natural language query from a device associated with access control information;
invoke evaluation of the natural language query and at least a portion of a schema of commands for accessing and viewing data by a large language model (LLM) to obtain a command referencing the data;
verify access to the data according to the access control information; and
in response to verifying access to the data according to the access control information, execute the command with respect to a command interpreter to act upon the data.

12. The non-transitory computer-readable medium of claim 11, wherein the executable code, when executed by the one or more processing devices, further causes the one or more processing devices to invoke evaluation of the natural language query and the at least the portion of the schema by the LLM by refraining from passing any portion of the data to the LLM.

13. The non-transitory computer-readable medium of claim 11, wherein the at least the portion of the schema comprise one or more commands through the schema.

14. The non-transitory computer-readable medium of claim 13, wherein the executable code, when executed by the one or more processing devices, further causes the one or more processing devices to identify the one or more commands through the schema as being relevant to the natural language query.

15. The non-transitory computer-readable medium of claim 13, wherein the one or more commands through the schema reference one or more visualizations for the data.

16. The non-transitory computer-readable medium of claim 15, wherein the executable code, when executed by the one or more processing devices, further causes the one or more processing devices to render the data according to a visualization of the one or more visualizations referenced by the command.

17. The non-transitory computer-readable medium of claim 11, wherein the command is a uniform resource locator (URL).

18. The non-transitory computer-readable medium of claim 11, wherein the executable code, when executed by the one or more processing devices, further causes the one or more processing devices to pass a security context to the LLM, the security context including the access control information.

19. The non-transitory computer-readable medium of claim 11, wherein the executable code, when executed by the one or more processing devices, further causes the one or more processing devices to:
identify a document relevant to the natural language query from a document set;
incorporate the command in a response generated based on the document; and
return the response to a user device from which the natural language query was received.

20. The non-transitory computer-readable medium of claim 11, wherein the executable code, when executed by the one or more processing devices, further causes the one or more processing devices to:
identify a plurality of documents and/or commands relevant to the natural language query from a document set;
submit the command and the plurality of documents and/or commands to the LLM with an instruction to generate a response to the natural language query based on the plurality of documents and/or commands; and
return the response to a user device.
